(19) United States
(12) Patent Application Publication
(10) Pub. No.: US 2020/0141203 A1
(43) Pub. Date: May 7, 2020

(54) METHOD AND SYSTEM FOR SUPPLYING POWER FLUID TO A WELL PRESSURE CONTROL DEVICE

(71) Applicant: Noble Drilling Services Inc., Sugar Land, TX (US)

(72) Inventors: Hans H. J. Deul, Richmond, TX (US); Patrick O'Neill, Houston, TX (US); Matthew Sibrel, Missouri City, TX (US); Robert van Kuilenburg, Sugar Land, TX (US)

(21) Appl. No.: 16/220,329

(22) Filed: Dec. 14, 2018

Related U.S. Application Data
(63) Continuation of application No. PCT/US2017/037169, filed on Jun. 13, 2017.
(60) Provisional application No. 62/349,686, filed on Jun. 14, 2016.

(51) Int. Cl. E21B 33/035; E21B 33/06; E21B 33/064; F15B 1/027; F15B 1/08

(52) U.S. Cl. CPC E21B 33/0355; E21B 33/062; F15B 1/08; F15B 1/027; E21B 33/064

(57) ABSTRACT

A power fluid supply system for a well pressure control apparatus includes a control valve manifold in hydraulic communication between a fluid outlet of an hydraulic fluid accumulator and an hydraulic ram in the well pressure control apparatus. A pressurized gas accumulator is in fluid communication with a fluid inlet of the hydraulic fluid accumulator. A pressurized gas supply conduit extends from the pressurized gas accumulator to a source of pressurized gas.

### CROSS REFERENCE TO RELATED APPLICATIONS

Continuation of International (PCT) Application No. PCT/US2017/037169 filed on Jun. 13, 2017. Priority is claimed from U.S. Provisional Application No. 62/349,686 filed in Jun. 14, 2016. Both the foregoing applications are incorporated herein by reference in their entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of subsea well pressure control apparatus such as blowout preventers (BOPs). More specifically, the disclosure relates to methods and systems for supplying power fluid under pressure to operate various elements of a blowout preventer such as a subsea blowout preventer.

Marine wellbore drilling techniques known in the art include the use of a pressure control apparatus such as a blowout preventer (BOP) disposed proximate the water bottom and coupled to the upper end of a surface conduit or casing disposed in the well. The BOP may comprise one or more sets of reversibly operable closure and sealing elements, for example, “blind rams” which fully close an interior bore of the BOP housing to hydraulically isolate the well up to the blind rams in the BOP housing. “Shear rams” may be provided to enable cutting through conduit and/or drilling tools disposed within the bore in the BOP housing and subsequently closing to hydraulically isolate the well. Annular seals, for example closure and sealing elements configured to seal against the exterior of the conduit (“pipe rams”) without damaging the conduit, may be used where it is desired to hydraulically isolate the well while enabling a conduit such as drill pipe or drilling tools to pass through the BOP housing.

Each of the foregoing types of closure and sealing elements may be disposed in opposed pairs on the BOP housing and may be operated by respective hydraulic rams. Hydraulic fluid pressure to operate the various hydraulic rams may be controlled by an hydraulic fluid line extending from a control valve manifold to a drilling platform on the water surface, and by providing a plurality of accumulators each having hydraulic fluid and gas (e.g., nitrogen) under pressure to supply a relatively large volume of fluid rapidly in the event it becomes necessary to close any one or more of the closure and sealing elements in the BOP. The accumulators also can supply hydraulic fluid under pressure even in the event the hydraulic fluid line becomes blocked or disconnected.

A schematic diagram of a BOP power fluid system known in the art is shown in FIG. 1. An hydraulic fluid line 10 extends from a control valve manifold 14 to a platform (FIG. 1A) on the water surface. Hydraulic fluid under pressure may be provided by equipment (not shown) on the platform both to operate control valves in the control valve manifold 14 and to provide part or all of the volume of hydraulic fluid under pressure needed to operate rams 16 when it is necessary to close the various sealing elements (not shown separately) in the BOP stack (FIG. 1A). A plurality of accumulators 12 may be disposed proximate the control valve manifold 14. Each accumulator 12 may comprise a pressure vessel having therein a diaphragm or other fluid separation barrier, wherein part of the internal volume of each accumulator 12 may be filled with hydraulic power fluid on one side of the fluid separation barrier and gas, e.g., nitrogen, on the other side of the fluid separation barrier. The gas-filled portion of each accumulator 12 is pressurized to an amount related to the depth of water at which the BOP stack is disposed and the required operating pressure to displace the hydraulic fluid from the accumulators 12 to operate the rams. Thus, as a practical matter, the gas charge pressure increases with respect to water depth because the rams 16 must overcome hydrostatic pressure of the water in order to operate.

In many BOP power fluid systems known in the art, the gas pre-charge pressure is fixed. The ram closing pressure, gas expansion pressure loss and the hydrostatic pressure needed to be overcome may be accounted for by selecting a suitable number of accumulators and filling each accumulator with hydraulic power fluid to a selected fraction of the total internal volume thereof. It is necessary in such systems to select the accumulator gas pressure prior to setting the BOP proximate the water bottom. The maximum available charge pressure in the accumulators is therefore limited by the pressure capacity of the accumulator pressure vessel. Accumulators having charge pressure that is compensated for external hydrostatic pressure exist, but are infrequently used because of the risk of leakage through the pressure compensator. There exists a need for an improved hydraulic power fluid operating system for use with BOPs and BOP stacks.

### BRIEF DESCRIPTION OF THE DRAWINGS

FIG. 1A shows an example embodiment of a wellbore drilling system including a pressure control apparatus comprising one or more ram-actuated blowout preventers (BOPs).

FIG. 1 shows an hydraulic power fluid system known in the art prior to the present disclosure.

FIG. 2 shows an example embodiment of an hydraulic power fluid system according to the present disclosure.

### DETAILED DESCRIPTION

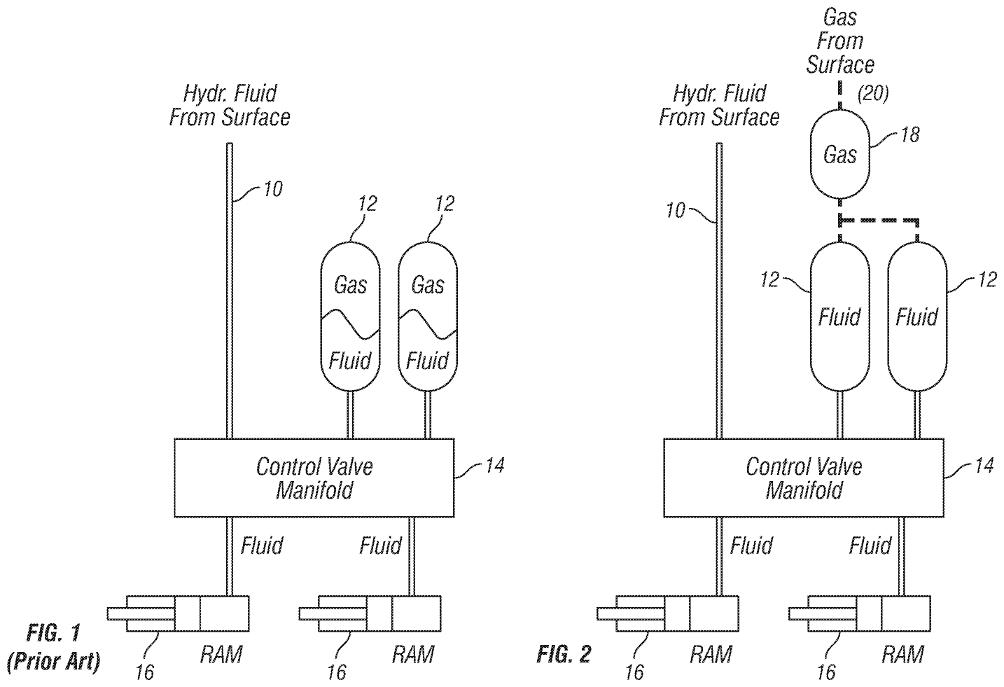

FIG. 1A shows an example embodiment of a well drilling system that may use well pressure control apparatus, i.e., ram actuated BOPs according to various aspects of the present disclosure. A drilling vessel 110 is shown floating on a body of water 113; in other embodiments the drilling vessel may be bottom-supported. A wellbore 122 being drilled below the water bottom 117 may be equipped with well pressure control apparatus according to the present disclosure. A wellhead 115 is positioned proximate the water bottom (sea floor) 117, which defines the upper surface or “mudline” of sub-bottom formations 118 through which the wellbore 122 extends. A drill string 119 and associated drill bit 120 are suspended from a derrick 121 mounted on the drilling vessel 110. The drill string 119 is shown in FIG. 1A as extending from the derrick 121 to the bottom of the wellbore 122. A length of structural casing 127 extends from the wellhead 115 to a selected depth into the bottom sediments 118 in the wellbore 122. The drill string 119 is nested in a riser 123 which is positioned between the upper end of a blowout preventer (BOP) stack 124 and the drilling vessel 110. The BOP stack 124 may be mounted at its lower end to the upper end of the wellhead 115.

At each end of riser 123 there may be a swivel coupling such as a ball joint 125. The riser 123 may be coupled to the upper end of the BOP stack 124 through a lower marine riser package LMRP of types well known in the art.

A drill floor 130 may form part of the drilling vessel 110; the drill floor 130 may be supported by a substructure 132. The riser 123 may be held in tension by tensioning wires 136 extending between a tensioner ring 138 and the substructure 132 or the drill floor 130. A slip joint 134 may be provided proximate the upper end of the riser 123 to enable the riser 123 to accommodate “heave” of the drilling vessel 110 as a result of changes in the water surface elevation with reference to the water bottom 117.

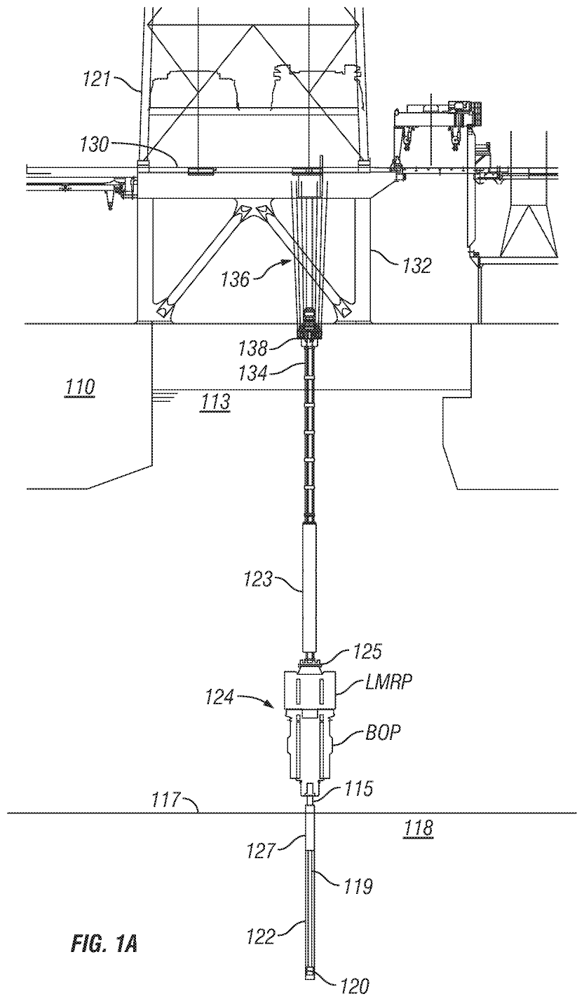

Certain features of the BOP stack 124 will be further explained with reference to FIG. 1 and FIG. 2. For purposes of defining the scope of the present disclosure, the BOP stack 124 may comprise at least one fluid pressure actuated closure element (RAM 16 in FIGS. 1 and 2), which when actuated closes a center bore (not shown separately) in the BOP stack 124. There may be more than one such closure element in various embodiments of the BOP stack 124, including well known arrangements where opposed pairs of such closure elements extend when actuated toward a center of the BOP stack 124 to close the center bore.

The example drilling system shown in FIG. 1A is only provided to show where in a marine drilling system a BOP or BOP stack may be located. The drilling methods and components described with reference to FIG. 1A are not intended to limit the scope of the present disclosure as it relates to BOPs and BOP stacks.

A schematic diagram of a BOP power fluid system according to the present disclosure is shown in FIG. 2. An hydraulic fluid line 10 extends from a control valve manifold 14 to a platform (e.g., drilling vessel 110 in FIG. 1A) on the water surface. Hydraulic fluid under pressure may be provided by equipment (not shown) on the platform (e.g., drilling vessel 110 in FIG. 1) both to operate control valves in the control valve manifold 14 and to provide part or all of the volume of hydraulic fluid under pressure needed to operate rams 16 when it is necessary to close the various sealing elements (not shown separately) in the BOP (see 124 in FIG. 1A). A plurality of accumulators 12 may be disposed proximate the control valve manifold 14. Each accumulator 12 may be substantially completely filled with hydraulic power fluid. A fluid outlet of each accumulator 12 may be coupled to suitable ports in the control valve manifold 14, and thus be made available to operate rams 16 when it is required to operate part or all the BOP (124 in FIG. 1A).

A fluid inlet of each accumulator 12 may be coupled to a pressurized gas accumulator 18. The pressurized gas accumulator 18 may be in fluid communication through a flow line 20 to a source or pressurized gas (not shown) on the platform (110 in FIG. 1A). During assembly of the BOP (124 in FIG. 1A) or BOP stack and the drilling riser (123 in FIG. 1A), as the BOP stack (124 in FIG. 1A) including operating rams 16, accumulators 12, control valve manifold 14 and the pressurized gas accumulator 18 are lowered into the water, gas (e.g., nitrogen, air or other inert gas) may be supplied from the platform (110 in FIG. 1A) through the flow line 20 to maintain gas pressure in the pressurized gas accumulator 18 at a selected pre-charge pressure related to the water depth. Because the accumulators 12, 18 do not have to be pre-charged to a pressure related to ultimate water depth of the BOP or BOP stack (124 in FIG. 1A), the burst pressure capacity of the accumulators 12, 18 may be substantially reduced as contrasted with accumulators known in the art prior to the present disclosure.

After completion of operations on a well, as the BOP (124 in FIG. 1A) including rams 16, control valve manifold 14 and accumulators 12, 18 are raised from near the water bottom to the water surface, gas pressure in the pressurized gas accumulator 18 may be gradually released such that the pressure in the accumulators 12, 18 does not exceed the safe internal pressure capacity of the accumulators 12, 18.

Advantages of a system according to the present disclosure may include one or more of the following. The pre-charge pressure is variable such that the final closing pressure (rams 16 fully closed) may be adjusted during running of the riser and BOP, rather than the need to fully pre-charge the accumulators 12 prior to assembling the riser/BOP. The individual accumulators 12 may be smaller since all of the accumulator volume can be used for fluid. Gas charge pressure can be maintained and changed during wellbore operations. The accumulator size is decoupled from water depth considerations. Central gas storage may allow for a situation-specific ram actuation sequence. Fewer accumulators 12 may be needed because they may be initially substantially fully filled with hydraulic fluid. Safety of the operation may be improved because it is not necessary to have high-pressure charged devices at the surface.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A power fluid supply system for a well pressure control apparatus, comprising:
a control valve manifold in hydraulic communication between a fluid outlets of at least one hydraulic fluid accumulator and at least one hydraulic ram in the well pressure control apparatus;
a pressurized gas accumulator in fluid communication with a fluid inlet of the at least one hydraulic fluid accumulator; and
a pressurized gas supply conduit extending from the pressurized gas accumulator to a source of pressurized gas.

2. The apparatus of claim 1 further comprising an hydraulic fluid line extending from the control valve manifold and a source of pressurized hydraulic fluid.

3. The apparatus of claim 1 further comprising a plurality of hydraulic fluid accumulators each in hydraulic communication at an outlet thereof with the control valve manifold, each of the plurality of hydraulic fluid accumulators in fluid communication at an inlet thereof with the pressurized gas accumulator.

4. The apparatus of claim 1 wherein the well pressure control apparatus comprises a plurality of hydraulic rams in fluid communication with the control valve manifold.

5. A method for installing a well pressure control apparatus onto a subsea well, comprising:
lowering a well pressure control apparatus into a body of water until the well pressure control apparatus reaches a selected depth in the body or water, the well pressure control apparatus comprising a control valve manifold in hydraulic communication between a fluid outlet of at least one hydraulic fluid accumulator and at least one hydraulic ram in the well pressure control apparatus, a pressurized gas accumulator in fluid communication with a fluid inlet of the at least one hydraulic fluid accumulator and a pressurized gas supply conduit extending from the pressurized gas accumulator to a source of pressurized gas on a platform on the surface of the body of water;
coupling the well pressure control apparatus to a wellhead; and
adjusting a gas pressure in the pressurized gas accumulator by moving gas from the source of pressurized gas to the pressurized gas accumulator to maintain a selected pressure therein related to the selected depth in the body of water.

6. The method of claim 5 further comprising lowering into the body of water a plurality of hydraulic fluid accumulators each in hydraulic communication at an outlet thereof with the control valve manifold, each of the plurality of hydraulic fluid accumulators in fluid communication at an inlet thereof with the pressurized gas accumulator.

7. The method of claim 5 wherein the well pressure control apparatus comprises a plurality of hydraulic rams in fluid communication with the control valve manifold.

8. The method of claim 5 wherein the lowering the well pressure control apparatus comprises coupling the well pressure control apparatus to a longitudinal end of a marine riser, and lengthening the marine riser from a platform on the surface of the body of water.

9. The method of claim 5 wherein the well pressure control apparatus comprises a blowout preventer.
